(19) United States
(12) Patent Application Publication
(10) Pub. No.: US 2021/0239606 A1
(43) Pub. Date: Aug. 5, 2021

(54) Computationally efficient method for retrieving physical properties from 7-14 um hyperspectral imaging data under clear and cloudy background conditions

(71) Applicant: Andrea Gabrieli, Honolulu, HI (US)

(72) Inventors: Andrea Gabrieli, Honolulu, HI (US); John N. Porter, Honolulu, HI (US)

(21) Appl. No.: 16/781,749

(22) Filed: Feb. 4, 2020

(51) Int. Cl. G01N 21/3504; G01J 3/28; G01J 3/10; G01N 21/27

(52) U.S. Cl. CPC G01N 21/3504; G01J 3/2823; G01N 2021/1795; G01N 21/27; G01J 3/108

(57) ABSTRACT

The present invention relates to a computationally compact and efficient method for determining physical characteristics of remote targets of interest from hyperspectral image scenes. Ground-based as well as space-borne hyperspectral imaging in the 7-14 microns region, also known as Thermal InfraRed (TIR) Hyperspectral imaging, is assuming increasing importance in military and civilian remote sensing. However, converting large hyperspectral imaging datasets into useable data products is complex and often requires long processing times. In-situ, field and on-board TIR hyperspectral imaging data processing is desirable for immediate detection, but currently very limited. Additionally, retrieving physical information of a target, seen against a background of clouds, is currently not possible. The present method creates a way to significantly improve the efficiency of analyzing hyperspectral imaging data to retrieve characteristics of remote targets of interest in the presence of both clear and cloudy sky background conditions. The present method uses a supervised machine learning Partial Least Squares Regression (PLSR) algorithm, which was trained from a library of simulated radiative transfer spectra. The radiative transfer library included a large number of complex conditions, which are difficult to implement in traditional lookup table methods, but become amenable in the present method. This invention is computationally compact and efficient and can be employed for on-board sensor data processing on the ground and in space. Various tests have shown the efficiency and reliability of the present method.

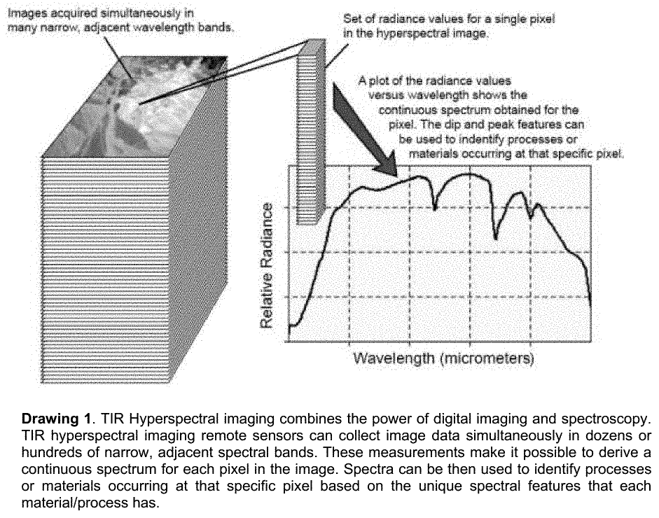

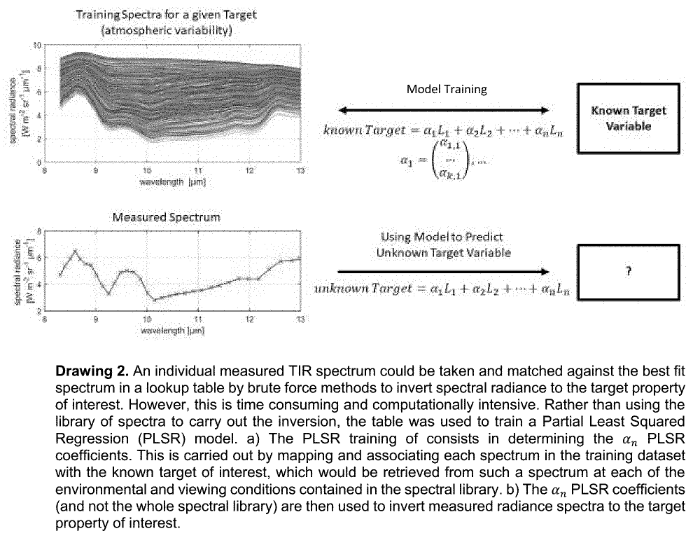

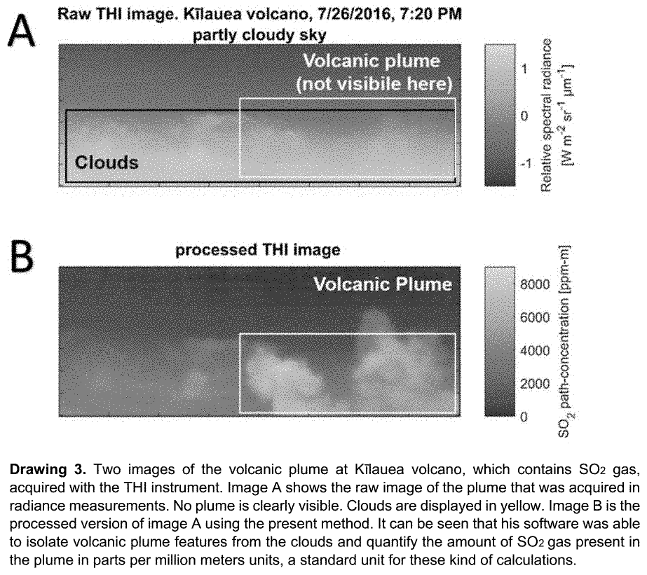

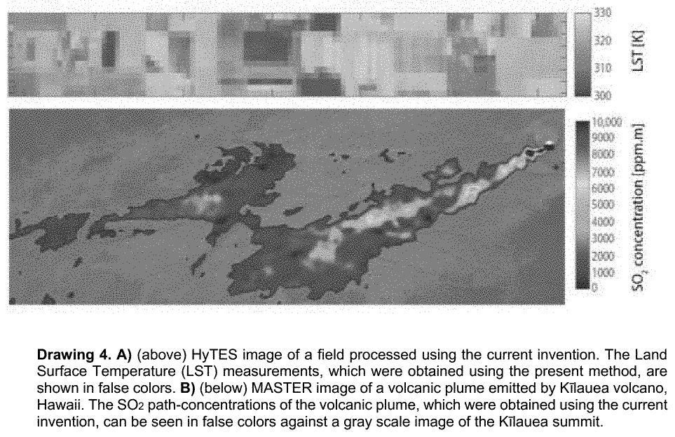

The subject matter herein was developed in part under research contracts provided by the U.S. Government, National Aeronautics and Space Administration (NASA), Earth Science Technology Office (ESTO), Instrument Incubator Program (IIP), Contract NNX14AE61G as well as under subcontract to the Jet Propulsion Laboratory (JPL), Subcontract number No. 1602222.

### SUBJECT OF THE INVENTION

### Technical Field of the Invention

This invention generally relates to the processing of hyperspectral imaging thermal infrared data between 7 and 14 microns at any spectral resolution to derive physical properties of targets of interest in a computationally compact and efficient manner.

### Background of the Invention

Thermal InfraRed (TIR) hyperspectral imaging deals with acquiring images of a scene and obtaining a spectrum, which is the characteristic distribution of the electromagnetic radiation emitted or absorbed by the target between 7 and 14 microns, for each pixel in the image. TIR hyperspectral imaging combines the power of digital imaging and TIR spectroscopy. In fact, TIR hyperspectral imaging remote sensors can collect image data simultaneously in dozens or hundreds of narrow, adjacent spectral bands. These measurements make it possible to derive a continuous spectrum for each pixel in the image, as shown in Drawing 1. Spectral features then provide information regarding the physical properties of the target.

Converting acquired spectral data into final products is complex and often requires extensive computational capabilities (Fauvel et al. 2017; Qi et al. 2018). Generally, hyperspectral imaging data, acquired using in-situ and space-borne sensors, are firstly downlinked to a ground station and then processed and analyzed. Earth science data often exceeds 10 GB so, the action of downlinking the data implies long delays (Qi et al. 2018).

It would be ideal to have inversion algorithms capable of producing final science data products on-board (Du et al. 2009; Fauvel et al. 2017; Qi et al. 2018). In this way, only the final products, and the not the large raw spectral dataset, would be downlinked. However, current algorithms and available methods are computationally inefficient as they involve millions of floating points operation per pixel and can't be employed for on-board processing (Realmuto et al. 2018). Additionally, existing methods can't effectively deal with atmospheric properties, especially clouds (Hadji-Lazaro and Clerbaux 1999; Garcia-Cuesta et al. 2007; Prata and Bernardo 2014; Whitburn et al. 2016; Fauvel et al. 2017; Ren et al. 2019).

The present method is unique as it uses a supervised Partial Least Squares Regression (PLSR) model to derive characteristics of remote targets of interest (for example SO₂ gas, CO₂ gas, land surface temperature, remote wind measurements, etc.) under clear and cloudy background conditions. The model was trained from a large lookup table of radiative transfer spectra for realistic conditions, including clouds and aerosols. This method is computationally compact and efficient and can be employed for on-board processing dramatically reducing retrieval solutions. Various tests have shown the efficiency and reliability of the present method. For example, the present method for SO₂ gas retrievals requires 149 floating point operations per pixels while Realmuto's SO₂ inversion approach requires millions (Realmuto et al. 2017). Additionally, the technique works for both day and night and for both clear and cloudy sky background conditions.

### SUMMARY OF THE INVENTION

The present method creates a way to significantly improve the efficiency of analyzing hyperspectral imaging data to retrieve characteristics of remote targets of interest, including in the presence of background clouds. The method uses a supervised PLSR model, which was trained from an extensive library of simulated radiative transfer spectra, to derive characteristics of remote targets of interest (for example SO₂ gas, CO₂ gas, land surface temperature, remote wind measurements, etc.). The radiative transfer library included a large number of complex conditions, including clouds and aerosols. These diverse conditions are cumbersome to implement in a traditional lookup table method but become amenable in the present method. This method is computationally compact and efficient and can be employed for on-board processing, dramatically reducing retrieval times. Various tests (detailed below) have shown the efficiency and reliability of the present method.

### DETAILED DESCRIPTION OF THE INVENTION

Hyperspectral imaging, from ground or space, is important for both military and civilian remote sensing. However, converting large hyperspectral imaging datasets into useable data products is complex and often employs computationally inefficient algorithms (Realmuto et al. 2017). Employing inefficient inversion algorithms is not suitable for in-situ and/or on-board platforms (Qi et al. 2018). For example, processing TIR hyperspectral imaging data for trace gas retrievals might require cumbersome lookup tables. The TIR spectral radiance retrieved from a target is a unique function of the composition and state of the target and the foreground/background atmosphere. Lookup tables can be generated from radiative transfer calculations for a variety of realistic target/atmosphere conditions. Once lookup tables are created, they are difficult to use due to their computational inefficiencies and large size.

Rather than employing a lookup table for these retrievals, the lookup tables can be used to train a supervised PLSR model. This PLSR model is computationally efficient, compact, and amenable for many input/output cases. PLSR is suitable for these type of applications as it can predict outputs based on many input variables, where the inputs and outputs can be redundant, collinear and/or not independent (Hoskuldsson 1988; Martens and Naes 1989; Mattu et al. 2000; Rosipal and Kramer 2006; Lopez et al. 2013). Thus, it allows for a fast and efficient way to implement the inversion algorithm. For example, the PLSR method for SO₂ gas retrievals requires 149 floating point operations per pixels while Realmuto's SO₂ inversion approach requires millions (Realmuto et al. 2017).

1. Sequence of Events (also summarized in Drawing 2):

### Creation of Compact ALTA-Generated PLSR Models:

1. A user selects and defines the desired retrieved properties (for example SO₂ gas, CO₂ gas, land surface temperature, remote wind measurements, etc.) in relationship to various environmental conditions including viewing orientation, target cloud and aerosol geometry and other environmental conditions.

2. The user also defines the type of hyperspectral imaging sensor, wavelength window, spectral resolution and viewing geometries.

3. The user then selects the number of PLSR components to be used in the calculations.

4. The user finally defines a large number of atmospheric soundings data.

5. The method employs a radiative transfer model to calculate the at-sensor radiance for the combination of conditions described in steps 1-4 above.

6. The dataset is split into two separate datasets. The first dataset is used as a model training dataset, which is made of 80% of the lookup table spectra. The second dataset is used as a testing dataset, which is made of the remaining 20% spectra.

7. The method creates a PLSR model using the training dataset. The training process is carried out by mapping and associating each spectrum in the training dataset (80% of the lookup table spectra) with the corresponding target condition, which would be retrieved from such a spectrum at each of the environmental and viewing conditions contained in training library. This is implemented using the following equation:

$$known target = {α}_{1} {L}_{1} + {α}_{2} {L}_{2} + … + {α}_{n} {L}_{n}$$

$${α}_{1} = ( \begin{matrix}{α}_{1 , 1} \\ … \\ {α}_{k , 1}\end{matrix} ) , …$$

where n is the number of wavelength bands of the sensor, αₙ is the PLSR model coefficient at band n, Lₙ is the radiance at band n and k is the user-defined number of PLSR components.

8. The method explains between 70% and 90% of the variance in the training dataset so that the model is not over-trained with possible noise.

9. The performance of the PLSR model is evaluated by using the independent test dataset.

10. The αₙ model coefficients are saved as output allowing the PLSR model to be applicable to subsequent operations. This results in a compact method for deriving properties from TIR hyperspectral data.

### Using the Method to Analyze TIR Hyperspectral Imaging Data:

1. The PLSR model is used to invert measured radiance spectra to derive the target property of interest. This is carried out by simply vector multiplying the measured spectral radiance by the αₙ model coefficients. This process limits the operations that need to be computed to less than 149 floating point operations per pixel.

### Example of Invention Use (1): Sulfur Dioxide Gas Detection and Quantification from Ground-Based Thermal Infrared Hyperspectral Imaging Sensors

As a detection target, for this particular test, we considered sulfur dioxide (SO₂) volcanic gas emissions at Kīlauea volcano in Hawaii. A lookup table of simulated spectra was created by varying SO₂ plume gas concentrations, plume locations, plume sizes, viewing geometries and background materials in an attempt to simulate atmospheric conditions that occur at the summit of the volcano and in analog tropical volcanic scenarios. Such conditions are reported in Table 1.

An individual measured TIR spectrum could be taken and matched against the best fit spectrum in such cumbersome library by brute force methods to invert spectral radiance to SO₂ path-concentration. However, this is time consuming and computationally intensive. Rather than using the library of simulated spectra to convert radiance to path-concentration, the table was used to train a PLSR model, following the method described in this invention. The training process was carried out by mapping and associating each spectrum in the training dataset with the corresponding SO₂ path-concentration, which would be retrieved from such a spectrum at each of the environmental and viewing conditions. The PLSR coefficients (and not the whole simulated spectral library) are then used to invert the radiance spectra of the remaining 20% spectra to path-concentration to evaluate the performance of the model. Once the performance of the PLSR model is acceptable (% variance explained in the output is higher than 70%), the PLSR coefficients (and not the whole spectral library) are used to invert the measured radiance spectra to path-concentration.

TABLE 1
Conditions used to develop the lookup table
used to train the ALTA-generated PLSR model.

| Environmental and geometrical | Values used to train the ALTA- |
|---|---|
| parameters | generated PLSR model |
| SO₂ Concentrations | 0, 1, 3, 5, 7, 9, 11, 13, 15, and |
| | 17 ppm-v |
| Temperature and Humidity | Standard tropical atmosphere and 400 |
| Profile | daily soundings from 3 tropical |
| | locations. (365 soundings from Hilo |
| | and Lihue, Hawai'i, and 35 from San |
| | Juan, Puerto Rico. Only daytime |
| | soundings were used for Hilo). |
| Viewing Zenith Angles | 180, 170, 150, 120, 85, 80, 70, 60, |
| | 50, 40, 30, 20, 10 and 1° |
| Camera Height | 0, 0.5, 1, 5, 10, 15, 20 km |
| Plume-Ambient Temperature | 0, 5, 10° C. |
| Difference | |
| Plume Widths | 0.1, 0.3, 0.5, 1 km |
| Plume Base Height (above ground) | 0 km |
| Plume Top Height | 2.5 km |
| Clouds Types (for upward | Cumulus cloud layer: base 0.66 km, |
| looking sensors only) | top 3.0 km |
| | Altostratus cloud layer: base 2.4 km, |
| | top 3.0 km. |
| | MODTRAN5 standard cirrus and |
| | sub-visual cirrus clouds |
| Horizontal cloud sizes (for | 0.001, 0.005, 0.01, 0.02, 0.03, 0.07, |
| upward looking sensors only) | 0.1, 0.3, 0.5, 1 km |
| Cloud-Camera Distances (for | 0.25, 0.5, 0.75, 1, 2, 5 km (not |
| upward looking sensors only) | applicable to cirrus clouds) |
| Background materials (for | basalt, granite, urban street, urban |
| downward looking sensors only) | environment, forest, grassland and |
| | ocean water. |

Results obtained using the present invention to create PLSR models and process TIR hyperspectral imaging data, acquired using the Thermal Hyperspectral Imager (THI) sensor, when clouds are present are very encouraging. In fact, the current method can convert radiance measurements into SO₂ gas concentrations even when clouds are present. Drawing 2 shows two images of the plume at Kīlauea volcano, which contains SO₂ gas, acquired with the THI instrument. Image A shows a raw image of the plume. No plume is clearly present. The clouds, which appear in yellow, are disturbing the data acquisition due to their water vapor absorption and complex thermochemical properties. An image like A would be useless to Earth scientists, as it doesn't help to identify or quantify the SO₂ volcanic gas present in it. Image B is the processed version of image A using the present method. Radiance measurements were converted into SO₂ gas concentrations measurements. It can be seen that, despite the presence of the clouds, the method was able to identify the volcanic gas and quantify it in parts per million meters (ppm-m) units. Ppm-m is a standard unit for these kind of calculations. This is a very significant result.

### Example of Invention Use (2): Sulfur Dioxide Gas and Land Surface Temperature Measurements from Space-Borne Thermal Infrared Hyperspectral Imaging Sensors

Due to the lack of robust inversion algorithms for processing space-borne TIR hyperspectral imaging sensor data in the presence of clouds, the present invention was also tested on retrieving physical information from targets in such conditions. As part of this work, the current method was tested on retrieving airplane-based measurements of SO₂ emissions from Kilauea volcano, Hawaii and of Land Surface Temperature (LST), which is a key indicator for plant and crop health monitoring. MODIS/ASTER air-borne simulator (MASTER) datasets, acquired during the January/February 2018 HyspIRI (Hyperspectral InfraRed Imager) NASA campaign, were used to retrieve SO₂ path-concentrations from the air. Hyperspectral Thermal Emission Spectrometer (HyTES) datasets were used to retrieve LST. Results are shown in Drawing 4.

### BRIEF DESCRIPTION OF DRAWINGS AND TABLES

The patent or application file contains various drawings executed in color. Copies of this patent or patent application publication with color drawing(s) will be provided by the Office upon request and payment of the necessary fee.

Drawing 1. TIR Hyperspectral imaging combines the power of digital imaging and spectroscopy. TIR hyperspectral imaging remote sensors can collect image data simultaneously in dozens or hundreds of narrow, adjacent spectral bands. These measurements make it possible to derive a continuous spectrum for each pixel in the image. Spectra can be then used to identify processes or materials occurring at that specific pixel based on the unique spectral features that each material/process has.

Drawing 2. An individual measured TIR spectrum could be taken and matched against the best fit spectrum in a lookup table by brute force methods to invert spectral radiance to the target property of interest. However, this is time consuming and computationally intensive. Rather than using the library of spectra to carry out the inversion, the table was used to train a Partial Least Squared Regression (PLSR) model. a) The PLSR training of consists in determining the αₙ PLSR coefficients. This is carried out by mapping and associating each spectrum in the training dataset with the known target of interest, which would be retrieved from such a spectrum at each of the environmental and viewing conditions contained in the spectral library. b) The αₙ PLSR coefficients (and not the whole spectral library) are then used to invert measured radiance spectra to the target property of interest.

Drawing 3. Two images of the volcanic plume at Kilauea volcano, which contains SO₂ gas, acquired with the THI instrument. Image A shows the raw image of the plume that was acquired in radiance measurements. No plume is clearly visible. Clouds are displayed in yellow. Image B is the processed version of image A using the present method. It can be seen that his software was able to isolate volcanic plume features from the clouds and quantify the amount of SO₂ gas present in the plume in parts per million meters units, a standard unit for these kind of calculations.

Drawing 4. A) (above) HyTES image of a field processed using the current invention. The Land Surface Temperature (LST) measurements, which were obtained using the present method, are shown in false colors. B) (below) MASTER image of a volcanic plume emitted by Kilauea volcano, Hawaii. The SO₂ path-concentrations of the volcanic plume, which were obtained using the current invention, can be seen in false colors against a gray scale image of the Kilauea summit.

Table 1. Conditions used to develop the lookup table used to train the ALTA-generated PLSR model.

### REFERENCE CITED

Du Q. A., Nekovei R. (2009) Fast real-time onboard processing of hyperspectral imagery for detection and classification. J. Real-Time Image Process 4:273-286. doi: 10.1007/s11554-008-0106-9
Fauvel, M., Girard, S., Douté, S., Gardes, L. (2017). Machine Learning Methods for the inversion of Hyperspectral images. Albert Reimer. Horizons in World Physics, 290, Nova Science, pp. 51-77, 2017, 978-1-53610-817-0.
Gabrieli, A., R. Wright, P. G. Lucey, J. N. Porter, H. Garbeil, E. Pilger, M. Wood. (2016). Characterization and initial field test of a long wave thermal infrared hyperspectral imager for measuring SO₂ in volcanic plumes. Bulletin of Volcanology, DOI: 10.1007/s00445-016-1068-6.
Gabrieli, A., R. Wright, J. N. Porter, and P. G. Lucey. (2017). Validating the accuracy of SO₂ gas retrievals in the thermal infrared (8-14 μm). Bulletin of Volcanology, DOI: DOI 10.1007/s00445-017-1163-3.
Garcia-Cuesta, E., de la Torre, F., de Castro, A. J. (2007). A Comparative Study of Supervised Learning Techniques for the Radiative Transfer Equation Inversion. Proceedings of the World Congress on Engineering and Computer Science 2007 WCECS 2007, Oct. 24-26, 2007, San Francisco, USA
Hadji-Lazaro, J., Clerbaux C. (1999). An inversion algorithm using neural networks to retrieve atmospheric CO total columns from high-resolution nadir radiances. Journal of Geophysical Research, 104, D19: 23841-23854
Hoskuldsson, P. (1988), PLS Regression Methods, Journal of Chemometrics, 2, 211-228.
Lopez, F., Nicolau, V., Maldague, X., Ibarra-Castanedo, C., (2013). Advances in Signal Processing for Non Destructive Evaluation of Materials. Proceedings of the VIIth International Works. 16th International Symposium on Applied Electromagnetics and Mechanics (ISEM 2013)
Martens, H., Naes, T. (1989). Multivariate Calibration. Wiley, New York. Z. Mathematical Reviews (MathSciNet): MR91e:62050
Mattu, M. J., G. W., Small, R. J., Combs, R. B., Knapp, R. T., Kroutil, (2000) Quantitative Analysis of Sulfur Dioxide with Passive Fourier Transform Infrared Remote Sensing Interferogram Data. Applied Spectroscopy, 54, 341-348
Qi, B., Shi, H., Zhuang, Y., Chen, H., Chen, L. (2018). On-Board, Real-Time Preprocessing System for Optical Remote-Sensing Imagery. Sensors, v.18(5); PMC5982232
Realmuto, V. J. and Thompson, D. R. (2018). The Application of SBG-Class Observations to Monitor Volcanic Gas and Aerosol Plumes in Hawaii. HyspIRI/SBG 2018 Science Workshop [Online]. Available at <https://hyspiri.jpl.nasagov/documents/2018-workshop/>
Ren, T., Modest, M. F., Fateev, A., Sutton, G., Zhao, W., Rusu, F. (2019). Machine learning applied to retrieval of temperature and concentration distributions from infrared emission measurements. Applied Energy 252 (2019) 113448
Rosipal, R., and N. Kramer (2006) Overview and recent advances in partial least squares. Subspace, Latent Structure and Feature Selection: Statistical and Optimization Perspectives Workshop (SLSFS 2005), Revised Selected Papers (Lecture Notes in Computer Science 3940), pp. 34-51, Springer-Verlag, Berlin, Germany.
Whitburn, S., Van Damme, M., Clarisse, L., Bauduin, S., Heald, C. L., Hadji-Lazaro, J., Hurtmans, D., Zondlo, M. A., Clerbaux, C., Coheur, P. F. (2016). A flexible and robust neural network IASI-NH3 retrieval algorithm. J. Geophys. Res. Atmos., 121, 6581-6599, doi:10.1002/2016JD024828.
Wright, R., Lucey, P., Crites, S., Horton, K., Wood, M., & Garbeil, H. (2013). BBM/EM design of the thermal hyperspectral imager: An instrument for remote sensing of earth's surface, atmosphere and ocean, from a microsatellite platform. Acta Astronautica, 87, 182-192.

1. A method for TIR Hyperspectral imaging on-board small platform environments, comprising: producing lookup tables of simulated spectral radiance using radiative transfer algorithms for a variety of conditions (viewing geometry, surface temperature, surface emissivity and atmospheric vertical profiles of constituent concentrations, temperature, humidity, clouds and aerosols) and creating Partial Least Squares Regression (PLSR) models for retrieving physical properties of targets of interest.

2. A method according to claim 1, wherein said TIR hyperspectral imaging systems, lookup tables of simulated spectral radiances and PLSR models are used to retrieve surface physical properties, including: surface temperature, chemical composition, vegetation coverage, hot spots from fires and volcanoes, etc. in the presence of unknown temperature and humidity profiles and clouds.

3. A method according to claim 1, wherein said TIR hyperspectral imaging systems, lookup tables of simulated spectral radiances and PLSR models are used to retrieve physical properties of atmospheric trace gases.

4. A method according to claim 1, wherein said TIR hyperspectral imaging systems, lookup tables of simulated spectral radiances and PLSR models are used to classify biological signatures such as marine algae, forests, grasslands, etc.

5. A method according to claim 1, wherein said TIR hyperspectral imaging systems, lookup tables of simulated spectral radiances and PLSR models are configured for use on small mobile platforms such as UAV vehicles or cube-sats allowing computational efficiency.

6. A method according to claim 1, wherein said TIR hyperspectral imaging systems, lookup tables of simulated spectral radiances and PLSR models are used to investigate food processing.

7. A method according to claim 1, wherein said TIR hyperspectral imaging systems, lookup tables of simulated spectral radiances and PLSR models are used to investigate and detect processes on biological tissues for medical applications.

8. A method according to claim 1, wherein said lookup tables of simulated spectral radiances and PLSR models are used to calibrate cooled and un-cooled TIR Hyperspectral imaging systems without employing external blackbodies.
